(19) United States
(12) Patent Application Publication
(10) Pub. No.: US 2023/0131105 A1
(43) Pub. Date: Apr. 27, 2023

(54) Identifying Test Dependencies Using Binary Neural Networks

(71) Applicant: EMC IP Holding Company LLC, Hopkinton, MA (US)

(72) Inventors: Ofir Ezrielev, Be'er Sheva (IL); Nadav Azaria, Be'er Sheva (IL); Yonit Weiss, Lehavim (IL)

(21) Appl. No.: 17/507,649

(22) Filed: Oct. 21, 2021

(51) Int. Cl. G06N 3/04

(52) U.S. Cl. CPC G06N 3/04

(57) ABSTRACT

A system can generate a neural network, wherein an output of the neural network indicates whether a first test of a computer code will pass given an input of respective results of whether respective tests, of a group of tests of the computer code, pass, and wherein respective weights of the neural network indicate a correlation from a group of correlations comprising a positive correlation between a respective output of a respective node of the neural network and the output of the neural network, a negative correlation between the respective output and the output, and no correlation between the respective output and the output. The system can apply sets of inputs to the neural network, respective inputs of the sets of inputs identifying whether the respective tests pass or fail. The system can, in response to determining that a first set of inputs of the sets of inputs to the neural network results in a failure output, storing an indication that the first test is dependent on a subset of the respective tests indicated as failing by the first set of inputs.

### BACKGROUND

A software codebase can be tested with multiple tests, which are automatically applied to the code base to test the code. These tests can have dependencies—e.g., if the codebase fails on test t1, then the codebase will also fail on test t2 and test t3 where t2 and t3 depend from t1.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can generate a neural network, wherein an output of the neural network indicates whether a first test of a computer code will pass given an input of respective results of whether respective tests, of a group of tests of the computer code, pass, and wherein respective weights of the neural network indicate a correlation from a group of correlations comprising a positive correlation between a respective output of a respective node of the neural network and the output of the neural network, a negative correlation between the respective output and the output, and no correlation between the respective output and the output. The system can apply sets of inputs to the neural network, respective inputs of the sets of inputs identifying whether the respective tests pass or fail. The system can, in response to determining that a first set of inputs of the sets of inputs to the neural network results in a failure output, storing an indication that the first test is dependent on a subset of the respective tests indicated as failing by the first set of inputs.

An example method can comprise applying, by a system comprising a processor, sets of inputs to a neural network, wherein an output of the neural network indicates whether a first test of a computer code passes given an input of respective results of whether respective tests of a group of tests of the computer code pass, wherein respective weights of the neural network indicate one of a positive correlation or a negative correlation between respective outputs of respective nodes of the neural network and the output of the neural network, and wherein respective inputs of the sets of inputs identifying whether the respective tests pass or fail. The method can further comprise, in response to determining that a first set of inputs of the sets of inputs to the neural network results in a failure, storing, by the system, an indication that the first test is dependent on a subset of the respective tests indicated as failing using the first set of inputs.

An example non-transitory computer-readable medium can comprise instructions that, in response to execution, cause a system comprising a processor to perform operations. These operations can comprise applying respective inputs to a binary neural network that determines whether a first test of a computer code passes given an input of respective results of whether respective tests of the computer code pass, and wherein the respective inputs identifying whether the respective tests pass or fail. These operations can further comprise, in response to determining that a first input of the respective inputs to the neural network results in an output indicating failure, storing an indication that the first test depends on a subset of the respective tests indicated as failing by the first input.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate identifying test dependencies using binary neural networks, in accordance with an embodiment of this disclosure;

FIG. 2 illustrates an example system architecture for identifying dependencies for one test that can facilitate identifying test dependencies using a binary neural network, in accordance with an embodiment of this disclosure;

FIG. 3 illustrates an example system architecture for identifying dependencies for multiple tests that can facilitate identifying test dependencies using a binary neural network, in accordance with an embodiment of this disclosure;

FIG. 4 illustrates an example system architecture for training a binary neural network to identify dependencies for multiple tests, in accordance with an embodiment of this disclosure;

FIG. 5 illustrates another example system architecture that can facilitate identifying test dependencies using binary neural networks, in accordance with an embodiment of this disclosure;

FIG. 6 illustrates an example process flow that can facilitate identifying test dependencies using binary neural networks, in accordance with an embodiment of this disclosure;

FIG. 7 illustrates another example process flow that can facilitate identifying test dependencies using binary neural networks, in accordance with an embodiment of this disclosure;

FIG. 8 illustrates another example process flow that can facilitate identifying test dependencies using binary neural networks, in accordance with an embodiment of this disclosure;

FIG. 9 illustrates an example process flow for determining that a test depends from multiple separate sets of tests, that can facilitate identifying test dependencies using binary neural networks, in accordance with an embodiment of this disclosure;

FIG. 10 illustrates an example process flow for reducing a number of inputs to apply to a binary neural network, that can facilitate identifying test dependencies using binary neural networks, in accordance with an embodiment of this disclosure;

FIG. 11 illustrates an example process flow for reducing a number of tests to apply to a codebase based on identifying test dependencies using binary neural networks, in accordance with an embodiment of this disclosure;

FIG. 12 illustrates an example block diagram of a computer operable to execute an embodiment of this disclosure.

### DETAILED DESCRIPTION

### Overview

Automatic tests can be an integral part of a software development cycle. In some examples, to get the most actionable information out test failures, it can be helpful to know which tests are dependent on each other (where test 1 depending on test 2 indicates that, if test 2 fails for given code, then test 1 will also fail). As an extreme example, one bug can cause the failure of hundreds of tests, where a developer can need to look at all or most of those tests to discover the reason for the bug. If, however, the developer had a way to know that all failed tests are dependent on one test, then the developer would have a much smaller scope to look at to fix the bug. The present techniques can be implemented to provide an automated approach to discover such dependencies, such as by using statistically using binary neural networks.

Binary neural networks can generally comprise a subfield of deep learning, in which weights (e.g., values in a neural network that scale an input value) of a neural network are binary (e.g., either −1 or 1, or either 0 or 1). There can also be a related form of binary neural networks referred to as trinary neural networks (e.g., where the possible weights are −1, 0, or 1). Using a binary (or trinary) neural network can be memory—and computationally—efficient relative to 32-bit or 64-bit weights, since a binary representation can be made with 1 bit.

Binary neural networks can underperform in some scenarios compared to their 32-bit or 64-bit counterparts, such as in regression problems or problems that have high numerical complexity with their input and feature interactions. However, binary neural networks can be implemented advantageously where the problem itself is binary in its input, feature interactions, and outputs. And, in some examples, determining test dependencies according to the present techniques can be expressed in a binary fashion (e.g., it is either TRUE or FALSE that one test depends from another test)

The present techniques can be implemented to predict test dependencies for tests that test a computer program code base, so as to decrease an amount of code that a developer needs to look at to fix bugs with the code. By decreasing the amount of code that a developer looks at, an expenditure of developer time and resources can be reduced for bug fixing. Implementing the present techniques can also speed a code development cycle.

Some present techniques to address test dependencies can involve manually labeling dependencies, such that if a test fails, the tests dependent on that failed test can be skipped instead of running and failing themselves.

Currently the practice of structuring test dependencies is relatively rare in software projects. Our team manually labeled dependencies for some of the tests, in the form that if a test fails, all tests dependent on it will be skipped instead of running and failing:

Manual dependency labeling can be both time-consuming and error-prone, and the present techniques can mitigate against these problems.

Additionally, where present techniques utilize learning algorithms, the use of binary neural networks in examples of the present techniques can lead to superior performance in computer resources used to identify test dependencies.

The present techniques can comprise training a binary neural network (e.g., in trinary form) over test results to discover correlations. The present techniques can also comprise discovering dependencies by artificially turning tests' success on and off in the neural network's input layer.

The present techniques can be implemented to provide an automatic, quicker way to reduce the scope of code a developer needs to look at to fix bugs.

The use of binary neural networks can be efficient. Binary neural networks can be more computationally and space efficient than other approaches that utilize a regular neural network, or another machine learning approach, and can be more interpretable relative to these other approaches.

Debugging is a known morale-dampening activity among developers. Developers who have a system that helps them understand test dependencies and thus help them fix bugs more easily in the future, can have more time for activities that bring them more satisfaction, make them more content, and thus more productive and happier.

Regarding identifying dependencies in multiple tests using one binary neural network, benefits of the present techniques relate to a unified and more-efficient system. Using a single binary neural network according to the present techniques can facilitate unifying many binary neural networks to one, saving space, saving training compute resources, reducing an amount of time required to elucidate dependencies after training, and providing an improved view of an overall test system. Additionally, by better structuring test dependencies build-test-fix cycles can be performed faster.

Additionally regarding identifying dependencies in multiple tests using one binary neural network, the present techniques can utilize binary 0-masking. In contrast to other value types in which 0 can confer meaning and be used by the neural network, in binary neural networks for a binary system, 0-masking can nullify an effect of the masked input.

### Example Architectures

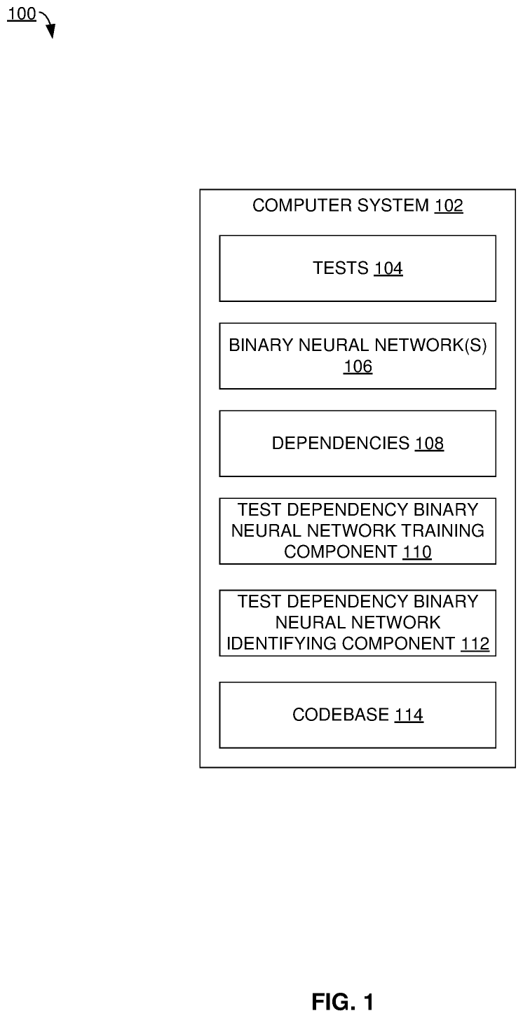

FIG. 1 illustrates an example system architecture 100 that can facilitate identifying test dependencies using binary neural networks, in accordance with an embodiment of this disclosure. System architecture 100 comprises computer system 102, which in turn comprises tests 104, binary neural network(s) 106, dependencies 108, test dependencies binary neural network training component 110, and test dependencies binary neural network identifying component 112.

Tests 104 can comprise one or more tests that tests a correctness of computer code of codebase 114. Dependencies 108 can identify dependencies between tests in tests 104 (e.g., test t1 depends from test t2 where t2 failing causes t1 to fail).

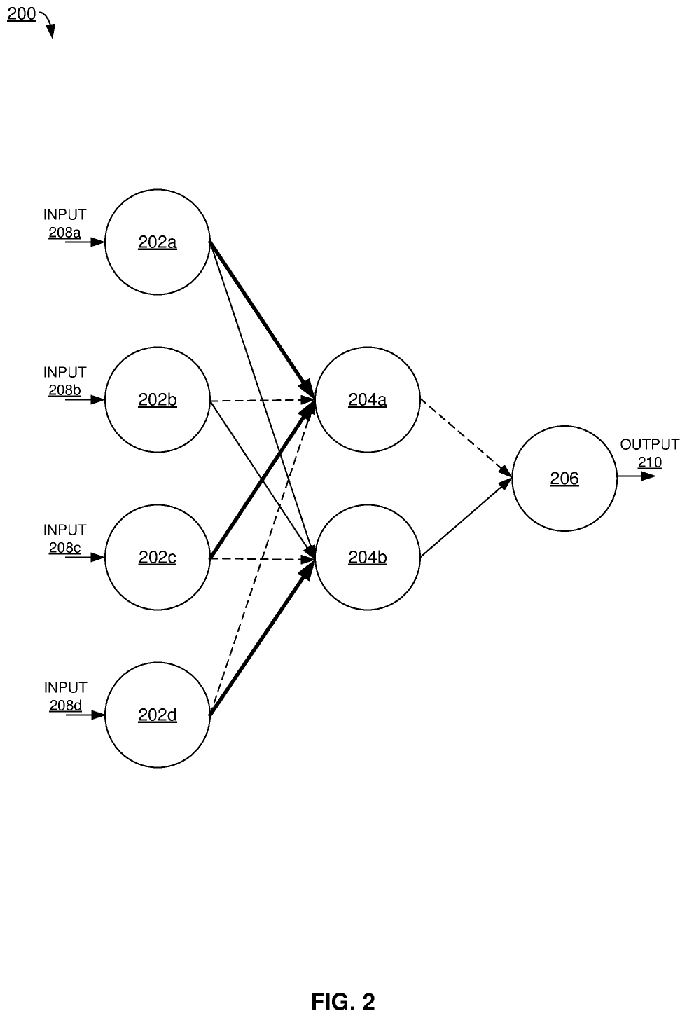

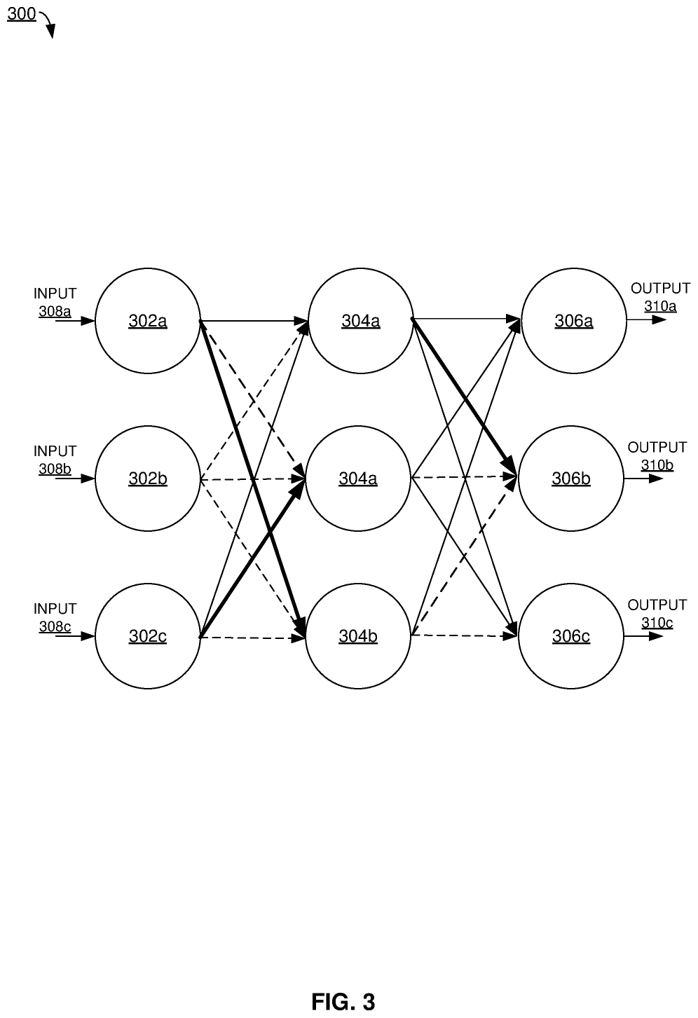

Binary neural network(s) 106 can comprise one or more binary neural networks that can use tests 104 as input to generate dependencies 108 as output. binary neural network(s) 106 can be similar to the binary neural network in system architecture 200 of FIG. 2, or in system architecture 300 of FIG. 3.

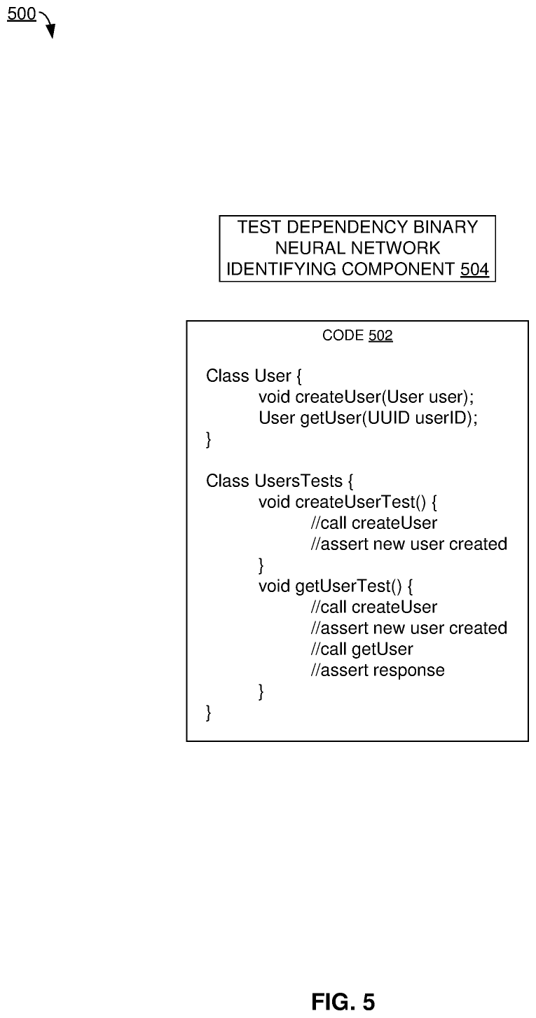

Test dependencies binary neural network training component 110 can train binary neural network(s) 106 to use tests 104 as input to generate dependencies 108 as output. In some examples, test dependencies binary neural network training component 110 can perform training similar to that described with respect to system architecture 500 of FIG. 5.

Test dependencies binary neural network identifying component 112 can use tests 104 as input to generate dependencies 108 as output. In some examples, test dependencies binary neural network identifying component 112 can perform dependency identification similar to that described with respect to system architecture 200 of FIG. 2 or system architecture 300 of FIG. 3.

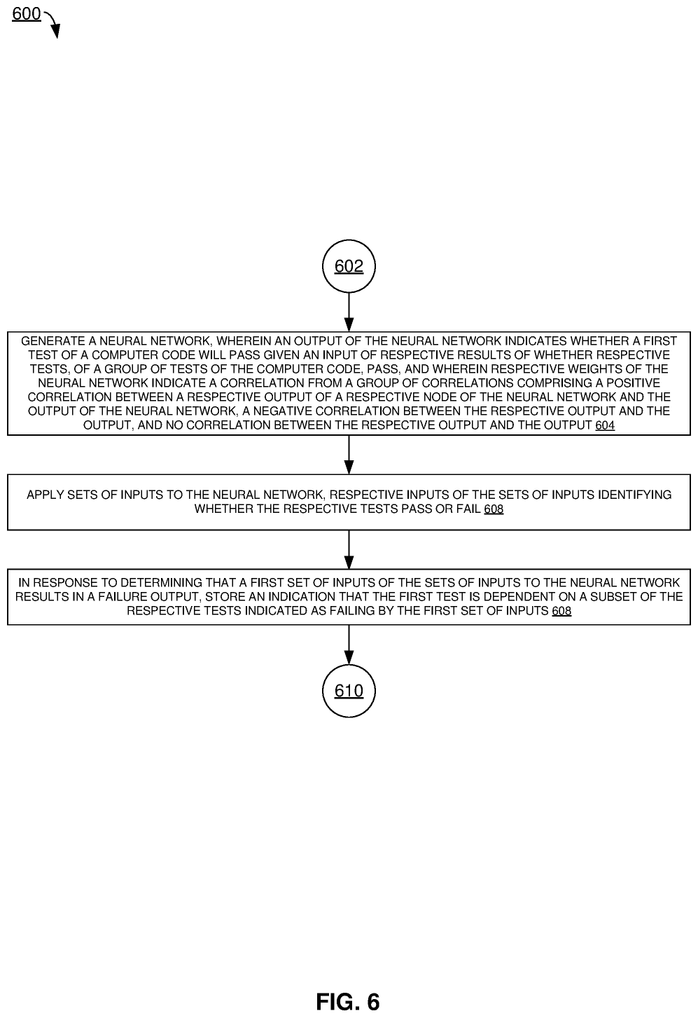

In facilitating identifying test dependencies using binary neural networks, system architecture 100 can implement part(s) of the process flows of FIGS. 6−11.

FIG. 2 illustrates an example system architecture 200 for identifying dependencies for one test that can facilitate identifying test dependencies using a binary neural network, in accordance with an embodiment of this disclosure. As depicted, system architecture 200 comprises node 202a, node 202b, node 202c, node 202d, node 204a, node 204b, node 206, input 208a, input 208b, input 208c, input 208d, and output 210.

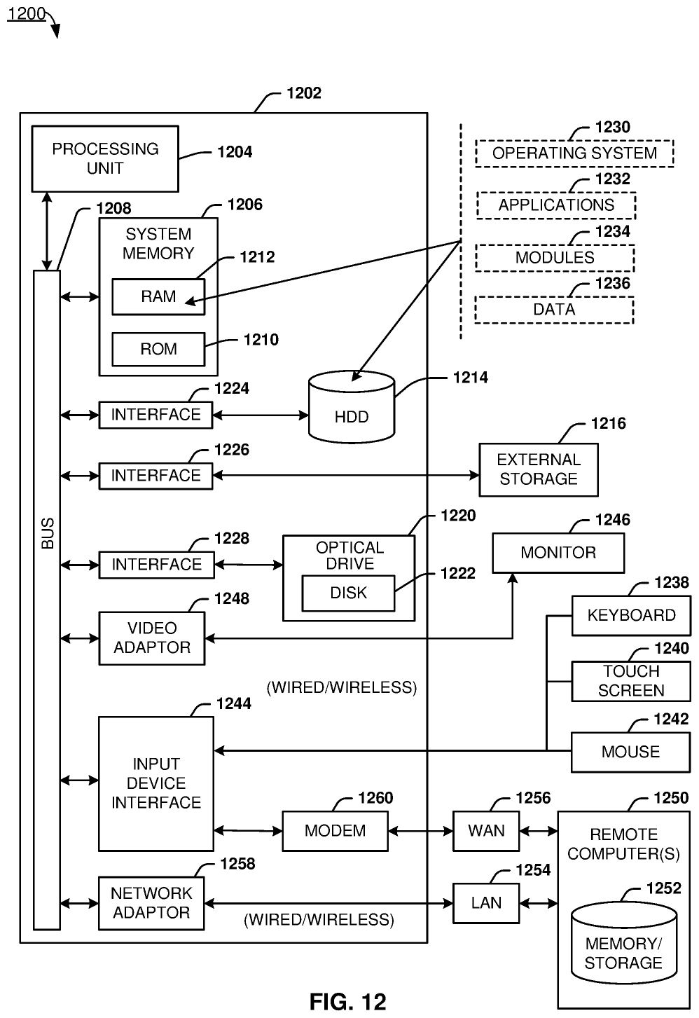

In some examples, system architecture 200 can be similar to binary neural network(s) 106 of FIG. 1, and can be implemented with part(s) of computing environment 1200 of FIG. 12.

System architecture 200 can comprise a binary neural network, with each of node 202a, node 202b, node 202c, node 202d, node 204a, node 204b, and node 206 being a node of that binary neural network, input 208a, input 208b, input 208c, and input 208d being inputs to the binary neural network, and output 210 being an output of the binary neural network.

System architecture 200 can comprise a binary neural network for five tests. Where there are five tests, four of those tests can each correspond to an input, and one test can correspond to an output. The inputs can be set to values that indicate whether a corresponding test passes (e.g., a value of +1) or fails (e.g., a value of −1), and an output can indicate whether a given test depends on that input combination of tests (e.g., the output test depends on the input value of tests when the output indicates failure (e.g., −1) and the output test does not depend on the input value of tests when the output value indicates success (e.g., +1)).

System architecture 200 can be utilized by providing different combinations of input values and measuring output 210. Where an output indicates that the test fails, an association can be stored between the test that corresponds to the output and the combination of failed tests that corresponds to the input values.

As depicted, node 202a, node 202b, node 202c, node 202d can be input nodes of an input layer of a binary neural network; node 204a and node 204b can be hidden nodes of a hidden layer of a binary neural network; and node 206 can be an output node of an output layer of a binary neural network. In the example of system architecture 200, a dashed line between nodes can indicate a value of −1, a solid line between nodes can indicate a value of +1, and a bolded solid line between nodes can indicate a value of 0.

Building and training a binary neural network according to system architecture 200 can be performed as follows. A neural network can be built that is similar in structure to a feedforward neural network, with binarized (or trinarized—−1, 0, and 1) weights that represent a negative correlation, no correlation, or a positive correlation between two tests. That is, −1 can denote failure, and 1 can denote success. Using a trinary version can be used to represent more complex logic in a neural network, where −1 can imply negative correlation, 0 can imply no correlation, and 1 can imply positive correlation inside of a neural network.

An input's dimensionality for n tests can be n−1, and can include results of all tests, excluding the test in question. The output dimension can be 1, which indicates a binary prediction of pass/fail. There can be a different binary neural network implemented for each test's dependency prediction. That is, where there are N tests, N binary neural networks can be generated, one binary neural network corresponding to each of the N tests. Once trained, elucidating dependencies using a trained neural network according to system architecture 200 can be performed as follows. S can be initialized as an empty set, S={ }. Where there are n tests (e.g., there is a dimensionality of n), for each of i=[1 . . . . [log η]], where [log η] is log n rounded up to a nearest integer, the following can be performed, expressed in pseudo code:

For all subsets S′ of tests with size i,
if S′ contains in full one of the elements of S, continue.
Predict over an input vector with 1's over the elements in S′ and −1 otherwise.
If the prediction is that the test fails, add S′ to S.
   When this is complete for each value of i, S can be returned as the test's dependencies. In some examples, adding more failures to a set of failures that already fails the test in question can be skipped because it does not provide more information. In addition, in some examples, the search can be clipped to size [log η] where there is a low probability that tests will depend on large sets of different tests, and to avoid exponential complexity.

A subset S′ can indicate a subgroup of the input tests that will be set to fail (e.g., have a value set to −1). Where a resulting output shows a prediction that the test corresponding to the output fails, it can be determined that that test depends on the group of tests in the input that are marked as failing.

FIG. 3 illustrates an example system architecture 300 for identifying dependencies for multiple tests that can facilitate identifying test dependencies using a binary neural network, in accordance with an embodiment of this disclosure. As depicted, system architecture 300 comprises node 302a, node 302b, node 302c, node 304a, node 304b, node 304c, node 306a, node 306b, node 306c, input 308a, input 308b, input 308c, output 310a, output 310b, and output 310c.

In some examples, system architecture 200 can be similar to binary neural network(s) 106 of FIG. 1, and can be implemented with part(s) of computing environment 1200 of FIG. 12.

While system architecture 200 of FIG. 2 can be implemented for determining dependencies for one test (corresponding to output 210), system architecture 300 can be implemented for determining dependencies for multiple tests (corresponding to each of output 310a, output 310b, and output 310c). That is, In some examples, a separate binary neural network can be created for each test. In some examples, one binary neural network can be created that covers multiple (or all tests), and that utilizes input masking to determine whether a particular test has dependencies.

As depicted, node 302a, node 302b, and node 302c can be input nodes of an input layer of a binary neural network; node 304a, node 304b, and node 304c can be hidden nodes of a hidden layer of a binary neural network; and node 306a, node 306b, and node 306c can be an output node of an output layer of a binary neural network. In the example of system architecture 300, a dashed line between nodes can indicate a value of −1, a solid line between nodes can indicate a value of +1, and a bolded solid line between nodes can indicate a value of 0. Various logic gates can be represented with derived binary operations in this system, and different kinds of dependencies can be represented in it.

For N tests, a binary neural network according to system architecture 300 can have N inputs and N outputs, each corresponding to one of the N tests. For example, system architecture 300 has three inputs (input 308a, input 308b, and input 308c) and three outputs (output 310a, output 310b, and output 310c).

Determining dependencies for multiple tests with a single binary neural network according to system architecture 300 can be performed as follows. A single binary neural network can be used, where an input and output dimensionality of the binary neural network can be equal to the number of tests (that is, in some examples, an identity function can be predicted with masking, to avoid direct approaches). For a test t to be trained, its index in an input vector to a binary neural network can be masked with a 0 value. Then, a loss can be determined based on that test's prediction. Training can be performed with epoch iterations first by each test, and then by minibatch. Once trained, the binary neural network can be used to identify dependencies for multiple (or all) tests at once.

In an example, pseudocode to train a binary neural network according to system architecture 300 can be as follows:

```
let D be the test results dataset, e be the number of epochs
let n ← number of tests in D
let NN ← an untrained binary neural network with input and output
dimensionality n for epoch i in range (e):
  for test t in D:
    for minibatch B in D:
      mask the input value of t in B
      loss ← |prediction of t by NN − true value of t|
        Update NN based on loss
```

That is, the pseudocode can effectuate training a binary neural network to predict an identity function without the entity itself, and given a set of different tests that are tested iteratively over time. In some examples, for each different test, during training, its input value can be masked (e.g., it is neither assigned a value of pass nor of fail), the masked input can be run on the masked tensor (vector generalization), and a loss can be determined for an output value of the binary neural network that corresponds to the masked test.

Finding dependencies according to system architecture 300 can be implemented by starting with a situation where an output for a particular test indicates failure. Then, iterations can be performed of going back through the binary neural network to identify sets of dependencies in hidden layers (e.g., a layer comprising node 304a, node 304b, and node 304c), until the input layer is reached. Those inputs to the input layer that indicate failing tests can be determined to be tests upon which there is a dependency.

A weight regularization term can be incorporated and controlled (where regularization can generally comprise adding information to a weight in order to mitigate against overfitting or to solve an ill-posed problem). In some examples, as a weight regularization term is increased, there can be more 0-valued weights. As a result, there can be a more simplified system with fewer false positives, though there some dependencies might not be identified.

In some examples, a binary neural network can first be trained with high regularization to determine stronger dependencies, and then with low regularization to determine less dominant dependencies (e.g., dependencies that are shown less often in data), which already-found dependencies used to limit a search space for the less dominant dependencies.

In some examples, tests can be added and removed over time. 0-masking certain inputs can be utilized by masking tests that are not run in a particular instance with zero values.

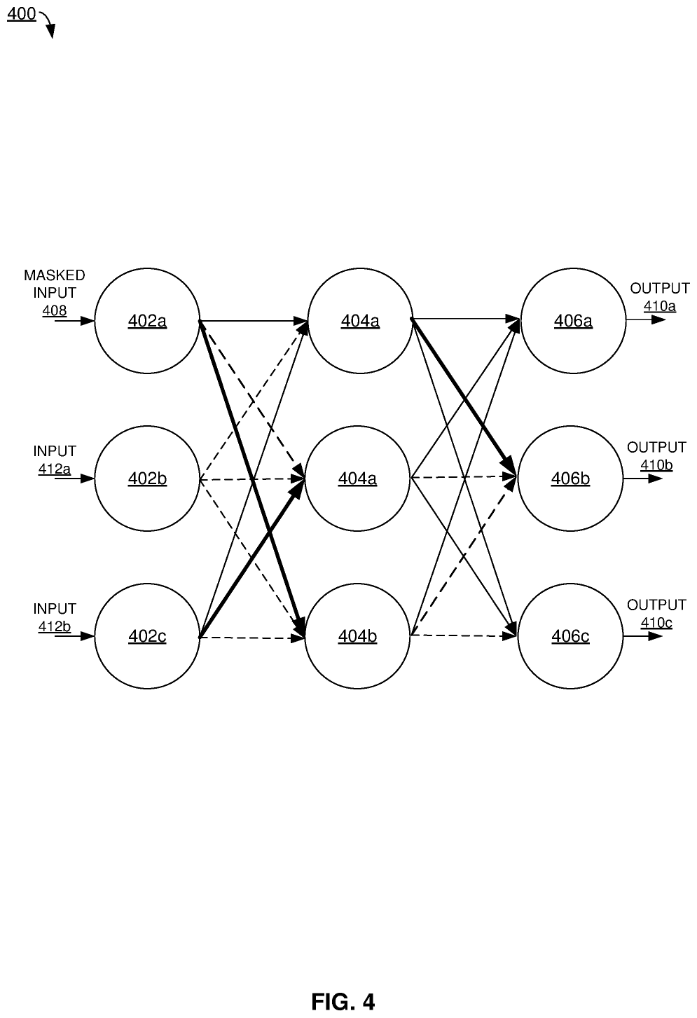

FIG. 4 illustrates an example system architecture for training a binary neural network to identify dependencies for multiple tests, in accordance with an embodiment of this disclosure. As depicted, system architecture 400 comprises node 402a, node 402b, node 402c, node 404a, node 404b, node 404c, node 406a, node 406b, node 406c, masked input 408, output 410, input 412b, and input 412b.

Where system architecture 300 of FIG. 3 can generally be used for identifying dependencies for multiple tests, system architecture 400 can generally be used for training such a binary neural network.

In some examples, node 402a, node 402b, node 402c, node 404a, node 404b, node 404c, node 406a, node 406b, and node 406c can be similar to node 302a, node 302b, node 302c, node 304a, node 304b, node 304c, node 306a, node 306b, and node 306c, respectively. Masked input 408 can comprise a masked input value (e.g., no input value provided, or an input value of 0, where −1 and +1 are recognized as valid input values, and 0 represents the lack of an input value). Input 412a and input 412b can comprise values of corresponding tests that indicate whether each test passes or fails.

Output 410 can indicate a predicted value used for loss computation that corresponds to masked input 408. That is, both masked input 408 and output 410 can correspond to the same test (e.g., test U), while input 412a and input 412b correspond to different tests (e.g., tests t2 and t3, respectively).

By masking different inputs (e.g., masking one t2 and t3 at a time) outputs indicating a predicted value used for loss computation for those respective tests can be determined, using system architecture 400.

In an example, pseudocode to use a binary neural network according to system architecture 400 can be as follows:

```
let NN be the trained binary neural network, n be the number of tests
let A ← n-dimensional array containing empty sets
for i = 1 ... [logn]:
  for all subsets of possible failing tests S:
  let S′ ← set of failing tests when NN predicts using S for failing tests
  in the input for test t ∈ S′:
    if t ∉ S and [symbol]  s ∈ A[t] s. t s ⊆ S′:
    add S′ to A[t]
```

That is, the pseudocode can effectuate utilizing a binary neural network (such as one trained according to system architecture 400 of FIG. 4) to find dependencies for tests. Iterations can be performed to supply the binary neural network with various sets of failing tests as inputs, and a resulting output can be analyzed to determine if the failure of the input tests indicates failure of other tests. If they do, and where there is not a subset of the set that indicates a failure of the other tests, this set of failure inputs can be identified as a dependency.

In other examples, inputs can be provided where some tests are neither marked as failing nor as passing (e.g., some tests are set as having 0-values indicating that there is no information for them) to determine dependencies for tests in resulting outputs. In some examples, this approach can facilitate identifying more complex dependencies.

FIG. 5 illustrates another example system architecture 500 that can facilitate identifying test dependencies using binary neural networks, in accordance with an embodiment of this disclosure. As depicted, system architecture comprises code 502 and test dependency binary neural network identifying component 504. Code 502 can be similar to codebase 114 of FIG. 1, and test dependency binary neural network identifying component 504 can be similar to test dependencies binary neural network identifying component 112.

Code 502 can have a problem where getUserTest fails where there is a defect in createUser. There can be examples where a test t1 (e.g., a test in tests 104 of FIG. 1) is dependent on a test t2 because t1 tests getUserTest and t2 tests createUser. That is, if t2 fails then t1 will also fail. This dependency between tests can be determined by test dependency binary neural network identifying component 504, and this dependency information can be used to both reduce a number of tests that are performed on code 502, as well as better identify where in code 502 a particular error is located.

### Example Process Flows

FIG. 6 illustrates an example process flow 600 that can facilitate identifying test dependencies using binary neural networks, in accordance with an embodiment of this disclosure. In some examples, one or more embodiments of process flow 600 can be implemented by computer system 102 of FIG. 1 or computing environment 1200 of FIG. 12.

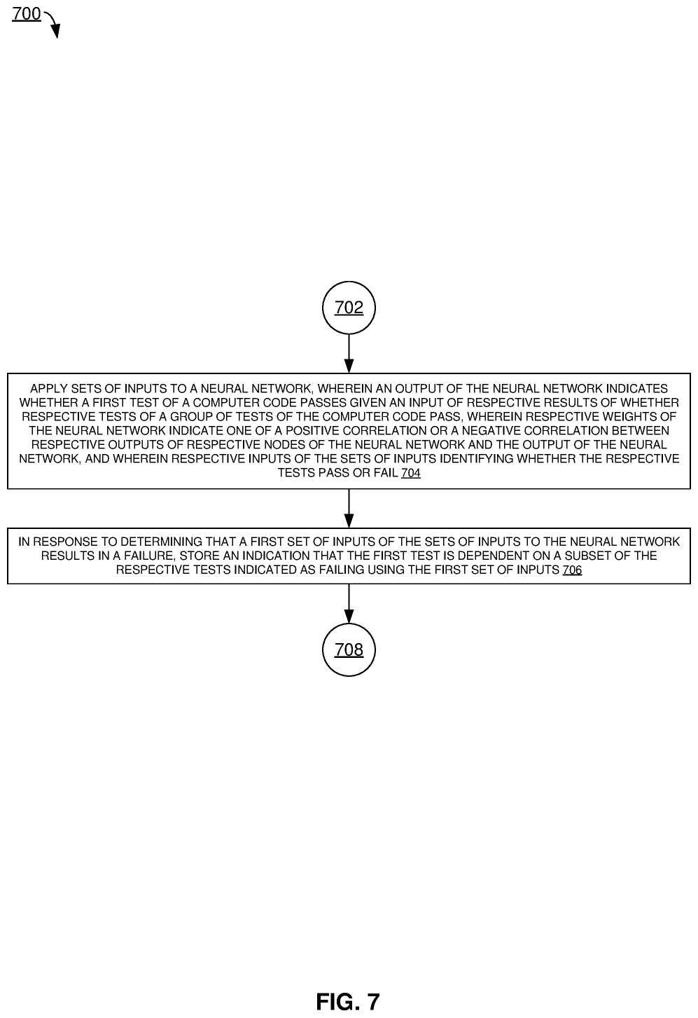

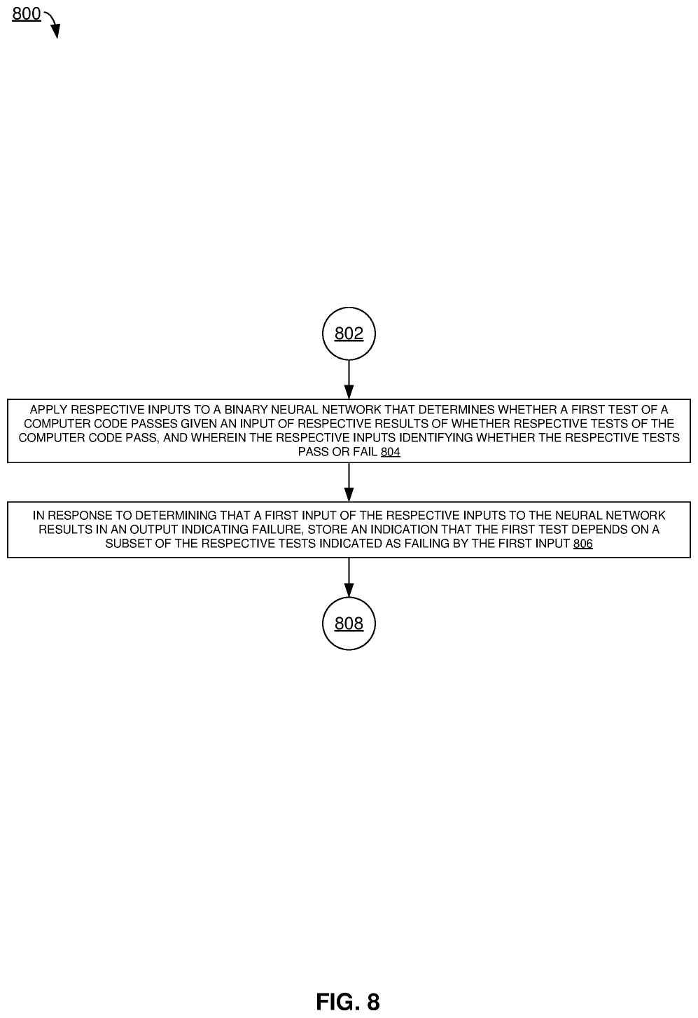

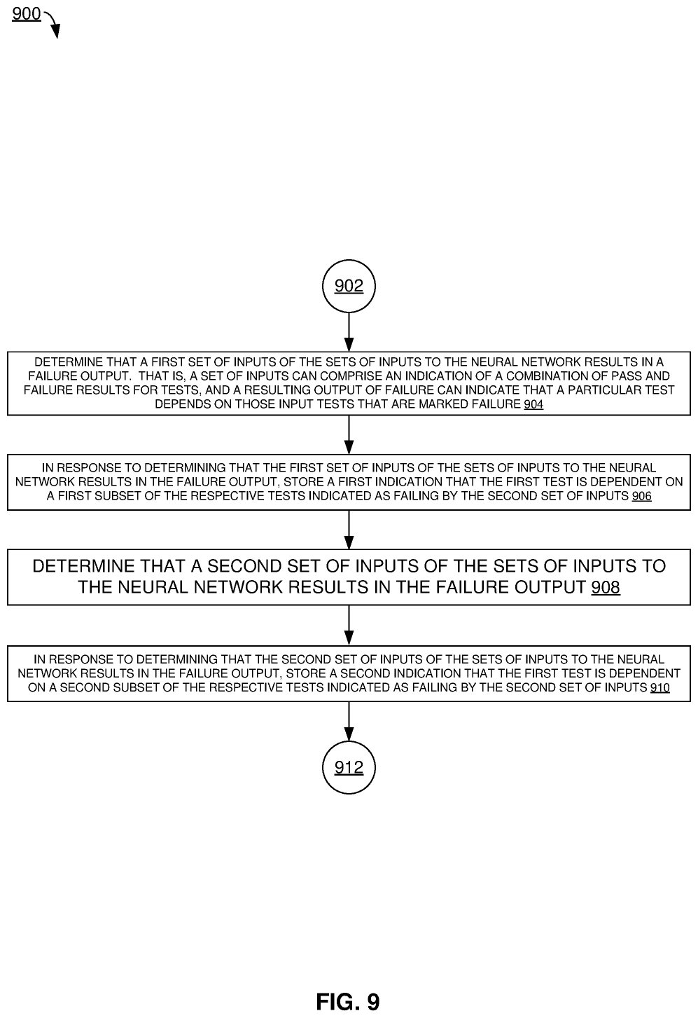

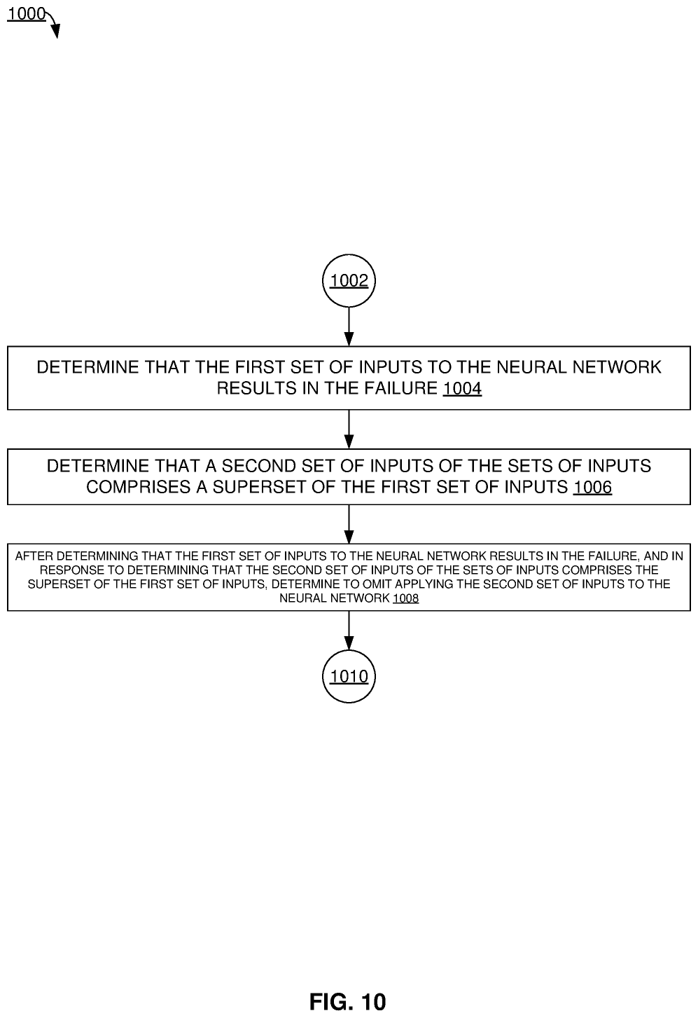

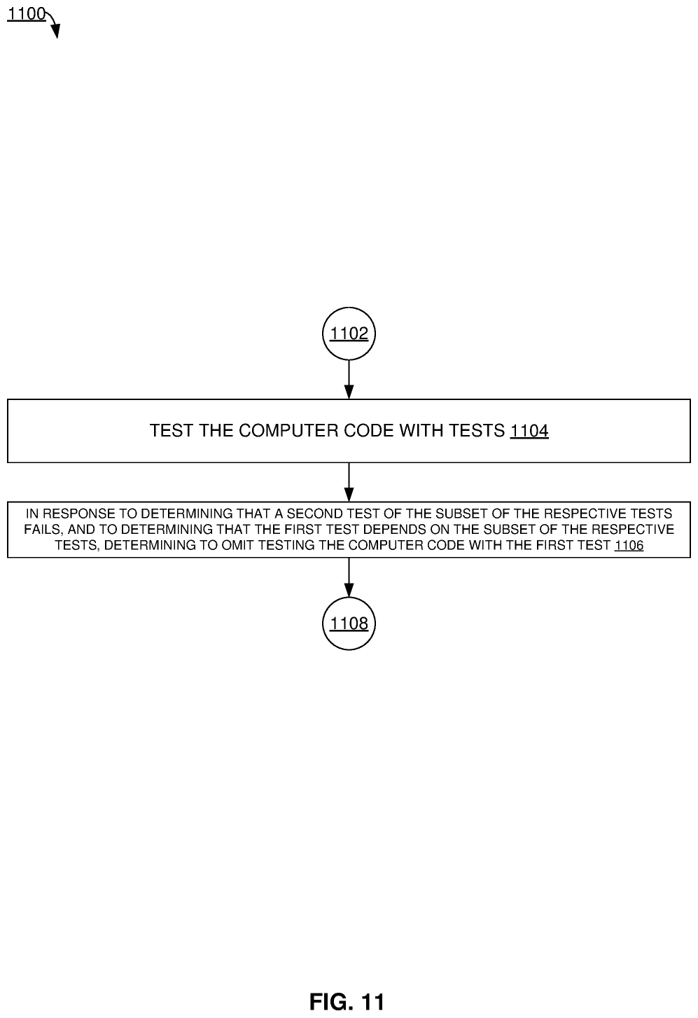

It can be appreciated that the operating procedures of process flow 600 are example operating procedures, and that there can be embodiments that implement more or fewer operating procedures than are depicted, or that implement the depicted procedures in a different order than as depicted. In some examples, process flow 600 can be implemented in conjunction with one or more embodiments of one or more of process flow 700 of FIG. 7, process flow 800 of FIG. 8, process flow 900 of FIG. 9, process flow 1000 of FIG. 10, and/or process flow 1100 of FIG. 11.

Process flow 600 begins with 602, and moves to operation 604. Operation 604 depicts generating a neural network, wherein an output of the neural network indicates whether a first test of a computer code will pass given an input of respective results of whether respective tests, of a group of tests of the computer code, pass, and wherein respective weights of the neural network indicate a correlation from a group of correlations comprising a positive correlation between a respective output of a respective node of the neural network and the output of the neural network, a negative correlation between the respective output and the output, and no correlation between the respective output and the output. That is, a binary neural network can be generated for a particular test. This binary neural network's inputs can indicate that other tests pass or fail, and the output can indicate whether this particular test will pass given the state of those other tests.

In some examples, the output is a first output, and wherein the neural network comprises a number of outputs that corresponds to a number of tests of the group of tests. That is, the binary neural network can have multiple outputs that identify dependencies of multiple respective tests, similar to system architecture 400 of FIG. 4.

In some examples, the sets of inputs mask a value of a first input to the neural network, the first input identifying whether the first test passes or fails. In some examples, the first input is configured to indicate one of the first test passing, the first test failing, and no indication of whether the first test passes or fails, and wherein the value of the first test is masked to provide no indication of whether the first test passes or fails. That is, binary 0-masking can be used, similar to masked input 408 of FIG. 4.

After operation 604, process flow 600 moves to operation 606.

Operation 606 depicts applying sets of inputs to the neural network, respective inputs of the sets of inputs identifying whether the respective tests pass or fail. That is, permutations of input values can be applied to the binary neural network (e.g., one permutation can be that test 1 passes and test 2 fails, another permutation can be that both test 1 and test 2 fail, etc.).

After operation 606, process flow 600 moves to operation 608.

Operation 608 depicts, in response to determining that a first set of inputs of the sets of inputs to the neural network results in a failure output, storing an indication that the first test is dependent on a subset of the respective tests indicated as failing by the first set of inputs. That is, where an output of the binary neural network indicates that the particular test fails, that can indicate that this test depends on the combination of input tests that are noted as failing.

In some examples, the output is a first output, and wherein the neural network comprises a number of outputs that corresponds to a number of tests of the group of tests. That is, the binary neural network can have multiple outputs that identify dependencies of multiple respective tests, similar to system architecture 400 of FIG. 4.

In some examples, the neural network is a first neural network, the sets of inputs are first sets of inputs, and operation 608 comprises applying second sets of inputs to a second neural network to determine whether a second test is dependent on a respective second set of the second sets of inputs. That is, there can be multiple binary neural networks, where each binary neural network identifies dependencies of a particular test, and they can be similar to system architecture 300 of FIG. 3.

In some examples, the indication is a first indication, wherein the first sets of inputs comprises a second indication of whether the second test passes, and wherein the second sets of inputs comprises a third indication of whether the first test passes. That is, multiple binary neural networks can be interrelated. For example, a first binary neural network can have a result of test 1 as an input and a result of test 2 as an output, and a second binary neural network can have a result of test 2 as an input and a result of test 1 as an output.

After operation 608, process flow 600 moves to 610, where process flow 600 ends.

FIG. 7 illustrates another example process flow that can facilitate identifying test dependencies using binary neural networks, in accordance with an embodiment of this disclosure. In some examples, one or more embodiments of process flow 700 can be implemented by computer system 102 of FIG. 1 or computing environment 1200 of FIG. 12.

It can be appreciated that the operating procedures of process flow 700 are example operating procedures, and that there can be embodiments that implement more or fewer operating procedures than are depicted, or that implement the depicted procedures in a different order than as depicted. In some examples, process flow 700 can be implemented in conjunction with one or more embodiments of one or more of process flow 600 of FIG. 6, process flow 800 of FIG. 8, process flow 900 of FIG. 9, process flow 1000 of FIG. 10, and/or process flow 1100 of FIG. 11.

Process flow 700 begins with 702, and moves to operation 704. Operation 704 depicts applying sets of inputs to a neural network, wherein an output of the neural network indicates whether a first test of a computer code passes given an input of respective results of whether respective tests of a group of tests of the computer code pass, wherein respective weights of the neural network indicate one of a positive correlation or a negative correlation between respective outputs of respective nodes of the neural network and the output of the neural network, and wherein respective inputs of the sets of inputs identifying whether the respective tests pass or fail. In some examples, operation 704 can be implemented in a similar manner as operations 604 and 606 of FIG. 6.

Ins some examples, the respective weights of the neural network indicate one of the positive correlation, the negative correlation, or no correlation between the respective outputs of the respective nodes of the neural network and the output of the neural network. That is, a binary neural network can have two values that respectively indicate positive correlation and negative correlation. And also, a value can be omitted, which can indicate no correlation.

In some examples, the respective inputs of the sets of inputs have an upper limit of inputs of the respective inputs that indicate failed tests, and wherein the upper limit is less than a number of tests in the group of tests. That is, a search space for dependencies can be reduced (e.g., be capped at log(n), where n is a number of inputs, rounded to an integer, failed tests). A reason for this can be to reduce processing time on identifying dependencies, where it is determined to be unlikely that dependencies will be identified based on many failed tests. In some examples, the upper limit is proportionate to a logarithm of a number of the respective tests.

In some examples, a number of inputs of the respective inputs that indicate failed tests vary between 1 and the upper limit. That is, a variable number of failed tests can be provided in an input. In some examples, this number of failed tests can vary between 1 and log(n).

In some examples, a first size of data that represents a first weight of the respective weights is smaller than a second size of word size of the processor, and wherein multiple weights of the respective weights are combined into a first word of the processor and processed in parallel. That is, a weight in a binary neural network can be expressed with a small number of bits (e.g., one or two bits). Where a binary neural network operates on a computer using a processor with a 64-bit size, multiple weights can be expressed within a word (as opposed to expressing one weight per word).

After operation 704, process flow 700 moves to operation 706.

Operation 706 depicts, in response to determining that a first set of inputs of the sets of inputs to the neural network results in a failure, storing an indication that the first test is dependent on a subset of the respective tests indicated as failing using the first set of inputs. In some examples, operation 706 can be implemented in a similar manner as operation 608 of FIG. 6.

After operation 706, process flow 700 moves to 708, where process flow 700 ends.

FIG. 8 illustrates another example process flow 800 that can facilitate identifying test dependencies using binary neural networks, in accordance with an embodiment of this disclosure. In some examples, one or more embodiments of process flow 800 can be implemented by computer system 102 of FIG. 1 or computing environment 1200 of FIG. 12.

It can be appreciated that the operating procedures of process flow 800 are example operating procedures, and that there can be embodiments that implement more or fewer operating procedures than are depicted, or that implement the depicted procedures in a different order than as depicted. In some examples, process flow 800 can be implemented in conjunction with one or more embodiments of one or more of process flow 600 of FIG. 6, process flow 700 of FIG. 7, process flow 800 of FIG. 8, process flow 1000 of FIG. 10, and/or process flow 1100 of FIG. 11.

Process flow 800 begins with 802, and moves to operation 804. Operation 804 depicts applying respective inputs to a binary neural network that determines whether a first test of a computer code passes given an input of respective results of whether respective tests of the computer code pass, and wherein the respective inputs identifying whether the respective tests pass or fail. In some examples, operation 804 can be implemented in a similar manner as operations 604 and 606 of FIG. 6.

In some examples, a dimensionality of the output of the binary neural network is equal to one. In some examples, a dimensionality of the respective inputs of the binary neural network is equal to a number of the respective tests that are separate from the first test. In some examples, a number inputs of the first input is equal to a number of tests of the respective tests that are separate from the first test. That is, a binary neural network similar to system architecture 300 can be implemented. In system architecture 300, for N tests, there are N−1 inputs, and 1 output.

In some examples, the binary neural network comprises a trinary neural network. That is, e.g., values of −1, 0, and +1 can be used.

After operation 804, process flow 800 moves to operation 806.

Operation 806 depicts, in response to determining that a first input of the respective inputs to the neural network results in an output indicating failure, storing an indication that the first test depends on a subset of the respective tests indicated as failing by the first input. In some examples, operation 806 can be implemented in a similar manner as operation 608 of FIG. 6.

After operation 806, process flow 800 moves to 808, where process flow 800 ends.

FIG. 9 illustrates an example process flow 900 for determining that a test depends from multiple separate sets of tests, that can facilitate identifying test dependencies using binary neural networks, in accordance with an embodiment of this disclosure. In some examples, one or more embodiments of process flow 900 can be implemented by computer system 102 of FIG. 1 or computing environment 1200 of FIG. 12.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 600 of FIG. 6, process flow 700 of FIG. 7, process flow 800 of FIG. 8, process flow 1000 of FIG. 10, and/or process flow 1100 of FIG. 11.

Process flow 900 can generally be used to identify multiple separate dependencies for a test. For example, test 1 could depend on test 2, and also on a combination of test 3 and test 4.

Process flow 900 begins with 902, and moves to operation 904. Operation 904 depicts determining that a first set of inputs of the sets of inputs to the neural network results in a failure output. That is, a set of inputs can comprise an indication of a combination of pass and failure results for tests, and a resulting output of failure can indicate that a particular test depends on those input tests that are marked failure.

After operation 904, process flow 900 moves to operation 906.

Operation 906 depicts, in response to determining that the first set of inputs of the sets of inputs to the neural network results in the failure output, storing a first indication that the first test is dependent on a first subset of the respective tests indicated as failing by the second set of inputs. That is, where a failure condition is observed as an output, the tests corresponding to the fail inputs that prompted that output can be saved as dependencies for the first test.

After operation 906, process flow 900 moves to operation 908.

Operation 908 depicts determining that a second set of inputs of the sets of inputs to the neural network results in the failure output. That is, a binary neural network can be provided with multiple sets of inputs, wherein each set of inputs identifies a combination of passing and failing tests. That is, a similar operation as operation 904 can be performed, this time in operation 908 with a different set of inputs.

After operation 908, process flow 900 moves to operation 910.

Operation 910 depicts, in response to determining that the second set of inputs of the sets of inputs to the neural network results in the failure output, storing a second indication that the first test is dependent on a second subset of the respective tests indicated as failing by the second set of inputs. Operation 910 can be performed in a similar manner as operation 906, so that multiple dependencies for one test can be identified and saved.

After operation 910, process flow 900 moves to 912, where process flow 900 ends.

FIG. 10 illustrates an example process flow 1000 for reducing a number of inputs to apply to a binary neural network, that can facilitate identifying test dependencies using binary neural networks, in accordance with an embodiment of this disclosure. In some examples, one or more embodiments of process flow 1000 can be implemented by computer system 102 of FIG. 1 or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 600 of FIG. 6, process flow 700 of FIG. 7, process flow 800 of FIG. 8, process flow 900 of FIG. 9, and/or process flow 1100 of FIG. 11.

Process flow 1000 can be implemented to reduce an amount of processing used to determine dependencies for a test. For example, where it is determined that a test depends on another test, then it can be determined that the test depends on all supersets of failure conditions that include the other test without providing those supersets to a binary neural network as inputs.

Process flow 1000 begins with 1002, and moves to operation 1004.

Operation 1004 depicts determining that the first set of inputs to the neural network results in the failure. For example, inputs for test 1 and test 2 can each be set to failure, and a resulting output can indicate failure (e.g., that the test in question depends from test 1 and test 2).

After operation 1004, process flow 1000 moves to operation 1006.

Operation 1006 depicts determining that a second set of inputs of the sets of inputs comprises a superset of the first set of inputs. Using the example of operation 1004, the second set of inputs can comprise inputs for test 1 and test 2 being set to failure, as above, and also an input for test 3 being set to failure. The superset can be a superset of those inputs that are set to failure.

After operation 1006, process flow 1000 moves to operation 1008.

Operation 1008 depicts, after determining that the first set of inputs to the neural network results in the failure, and in response to determining that the second set of inputs of the sets of inputs comprises the superset of the first set of inputs, determining to omit applying the second set of inputs to the neural network. That is, it can be determined that if a test depends on one set of failures, then it will also depend on a superset of those failures, so testing the superset can be skipped.

After operation 1004, process flow 1000 moves to 1010, where process flow ends.

FIG. 11 illustrates an example process flow 1100 for reducing a number of tests to apply to a codebase based on identifying test dependencies using binary neural networks, in accordance with an embodiment of this disclosure. In some examples, one or more embodiments of process flow 1000 can be implemented by computer system 102 of FIG. 1 or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 600 of FIG. 6, process flow 700 of FIG. 7, process flow 800 of FIG. 8, process flow 900 of FIG. 9, and/or process flow 1000 of FIG. 10.

Process flow 1100 can be implemented to test code, where dependencies for tests have been determined, e.g., using system architecture 300 of FIG. 3 or system architecture 400 of FIG. 4.

Process flow 1100 begins with 1102, and moves to operation 1104. Operation 1104 depicts testing the computer code with tests. This code can be codebase 114 of FIG. 1, and these tests can be tests 104.

After operation 1104, process flow 1100 moves to operation 1106.

Operation 1106 depicts, in response to determining that a second test of the subset of the respective tests fails, and to determining that the first test depends on the subset of the respective tests, determining to omit testing the computer code with the first test. That is, in some examples, if test 1 depends on test 2, and test 2 fails, then test 1 will fail. So, if test 2 is applied to the code and fails, then applying test 1 to the code can be skipped, since it can be determined that test 1 will fail.

After operation 1106, process flow 1100 moves to 1108, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of computer system 102 of FIG. 1.

In some examples, computing environment 1200 can implement one or more embodiments of the process flows of FIGS. 6−11 to facilitate identifying test dependencies using binary neural networks.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1294 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1294 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
generating a neural network, wherein an output of the neural network indicates whether a first test of a computer code will pass given an input of respective results of whether respective tests, of a group of tests of the computer code, pass, and wherein respective weights of the neural network indicate a correlation from a group of correlations comprising a positive correlation between a respective output of a respective node of the neural network and the output of the neural network, a negative correlation between the respective output and the output, and no correlation between the respective output and the output;
applying sets of inputs to the neural network, respective inputs of the sets of inputs identifying whether the respective tests pass or fail; and
in response to determining that a first set of inputs of the sets of inputs to the neural network results in a failure output, storing an indication that the first test is dependent on a subset of the respective tests indicated as failing by the first set of inputs.

2. The system of claim 1, wherein the output is a first output, and wherein the neural network comprises a number of outputs that corresponds to a number of tests of the group of tests.

3. The system of claim 2, wherein the sets of inputs mask a value of a first input to the neural network, the first input identifying whether the first test passes or fails.

4. The system of claim 3, wherein the first input is configured to indicate one of the first test passing, the first test failing, and no indication of whether the first test passes or fails, and wherein the value of the first test is masked to provide no indication of whether the first test passes or fails.

5. The system of claim 1, wherein the neural network is a first neural network, wherein the sets of inputs are first sets of inputs, and wherein the operations further comprise:
applying second sets of inputs to a second neural network to determine whether a second test is dependent on a respective second set of the second sets of inputs.

6. The system of claim 5, wherein the indication is a first indication, wherein the first sets of inputs comprises a second indication of whether the second test passes, and wherein the second sets of inputs comprises a third indication of whether the first test passes.

7. The system of claim 1, wherein the indication is a first indication, wherein the subset is a first subset, and wherein the operations further comprise:
in response to determining that a second set of inputs of the sets of inputs to the neural network results in the failure output, storing a second indication that the first test is dependent on a second subset of the respective tests indicated as failing by the second set of inputs.

8. A method, comprising:
applying, by a system comprising a processor, sets of inputs to a neural network, wherein an output of the neural network indicates whether a first test of a computer code passes given an input of respective results of whether respective tests of a group of tests of the computer code pass,
wherein respective weights of the neural network indicate one of a positive correlation or a negative correlation between respective outputs of respective nodes of the neural network and the output of the neural network, and
wherein respective inputs of the sets of inputs identifying whether the respective tests pass or fail; and
in response to determining that a first set of inputs of the sets of inputs to the neural network results in a failure, storing, by the system, an indication that the first test is dependent on a subset of the respective tests indicated as failing using the first set of inputs.

9. The method of claim 8, wherein the respective weights of the neural network indicate one of the positive correlation, the negative correlation, or no correlation between the respective outputs of the respective nodes of the neural network and the output of the neural network.

10. The method of claim 8, further comprising:
after determining that the first set of inputs to the neural network results in the failure, and in response to determining that a second set of inputs of the sets of inputs comprises a superset of the first set of inputs, determining, by the system, to omit applying the second set of inputs to the neural network.

11. The method of claim 8, wherein the respective inputs of the sets of inputs have an upper limit of inputs of the respective inputs that indicate failed tests, and wherein the upper limit is less than a number of tests in the group of tests.

12. The method of claim 11, wherein a number of inputs of the respective inputs that indicate failed tests vary between 1 and the upper limit.

13. The method of claim 11, wherein the upper limit is proportionate to a logarithm of a number of the respective tests.

14. The method of claim 8, wherein a first size of data that represents a first weight of the respective weights is smaller than a second size of word size of the processor, and wherein multiple weights of the respective weights are combined into a first word of the processor and processed in parallel.

15. A non-transitory computer-readable medium comprising instructions that, in response to execution, cause a system comprising a processor to perform operations, comprising:
applying respective inputs to a binary neural network that determines whether a first test of a computer code passes given an input of respective results of whether respective tests of the computer code pass, and wherein the respective inputs identifying whether the respective tests pass or fail; and
in response to determining that a first input of the respective inputs to the neural network results in an output indicating failure, storing an indication that the first test depends on a subset of the respective tests indicated as failing by the first input.

16. The non-transitory computer-readable medium of claim 15, further comprising:
after storing the indication, testing the computer code with the respective tests; and
in response to determining that a second test of the subset of the respective tests fails, and to determining that the first test depends on the subset of the respective tests, determining to omit testing the computer code with the first test.

17. The non-transitory computer-readable medium of claim 15, wherein a dimensionality of the output of the binary neural network is equal to one.

18. The non-transitory computer-readable medium of claim 15, wherein a dimensionality of the respective inputs of the binary neural network is equal to a number of the respective tests that are separate from the first test.

19. The non-transitory computer-readable medium of claim 15, wherein the binary neural network comprises a trinary neural network.

20. The non-transitory computer-readable medium of claim 15, wherein a number inputs of the first input is equal to a number of tests of the respective tests that are separate from the first test.
